(19) United States
(12) Patent Application Publication
(10) Pub. No.: US 2024/0279428 A1
(43) Pub. Date: Aug. 22, 2024

(54) HALOGEN FREE FLAME RETARDANT POLYMERIC COMPOSITIONS

(71) Applicant: Dow Global Technologies LLC, Midland, MI (US)

(72) Inventors: Paul J. Caronia, Annadale, NJ (US); Kurt A. Bolz, III, Allentown, NJ (US)

(21) Appl. No.: 18/568,360

(22) PCT Filed: Sep. 20, 2022
(86) PCT No.: PCT/US2022/044151

§ 371 Date: Dec. 8, 2023

Related U.S. Application Data
(60) Provisional application No. 63/246,454, filed on Sep. 21, 2021.

(51) Int. Cl. C08K 3/22; C08J 3/22; C08J 3/24; C08L 43/04

(52) U.S. Cl. CPC C08K 3/22; C08J 3/226; C08J 3/24; C08L 43/04; C08J 2300/108; C08J 2323/08; C08J 2343/04; C08J 2423/08; C08L 2310/00

(57) ABSTRACT

A method of forming a polymeric composition includes the steps of melt blending an ethylene-silane copolymer and a halogen free flame retardant masterbatch comprising halogen free flame retardant dispersed in an ethylene vinyl acetate copolymer to form the polymeric composition, wherein the ethylene-silane copolymer is a random copolymer of units derived from ethylene and vinyltrimethoxysilane and further wherein the copolymer has a vinyltrimethoxysilane content of 0.5 wt % to less than 2 wt % based on the total weight of the ethylene-silane copolymer; and processing the polymeric composition into a plurality of particles.

### BACKGROUND

### Field of the Invention

The present disclosure generally relates to polymeric compositions and more specifically to polymeric compositions including halogen free flame retardants.

### INTRODUCTION

Jacketing of wires and cables utilized in structures often must meet certain flame retardancy properties. Thermoplastic polymers are utilized as the base polymeric composition for such jacketing due to the case of incorporating high levels of halogen free flame retardant (“HFFR”) fillers in such materials. The HFFR fillers may be metal hydroxides or a variety of other materials. Depending on the intended use of the wire or cable, thermoset compositions may be desirable for the jacketing as thermoset resins offer enhanced heat and fluid resistance relative to thermoplastic compositions. Typical desired properties for the flame retardant compositions include having a hot creep elongation of 50% or less as measured according to Insulated Cable Engineers Association (“ICEA”) T-28-562, an unaged tensile modulus of 9 mPa or greater as measured according to ASTM D638, and an elongation at break of 150% or greater as measured according to ASTM D638.

The incorporation of HFFR filler into thermosettable resins poses a number of technical issues. In order to form a thermoset composition, a crosslinking agent is added to the composition. Crosslinking agents are typically organic peroxides for a free radical process or silane compounds for a condensation curing process. In a typical condensation curing process, a silane compound is grafted to a base resin. Grafted silane resins are used over ethylene-silane copolymers as grafted resins offer faster crosslinking speeds. The crosslinking, or curing, of the silane grafted resin occurs in the presence of water, heat and catalyst. Despite the advantage of faster curing speeds offered by the silane grafted resins, this approach presents a number of challenges. For example, the formation of HFFR containing silane-grafted resins is complicated because the HFFR materials tend to comprise water which may result in uncontrolled premature cross-linking. To overcome this issue, traditional approaches include a multiple step process where silane is grafted to the resin with subsequent steps of compounding in the HFFR and then extruding the composition with catalysts. One disadvantage of this method is that the silane grafted resin produced in advance of the compounding has a limited storage time before the silane functionality is reacted. Additionally, such a method often results in a non-homogenous dispersion of the HFFR in the silane grafted resin. The poor dispersion of the HFFR in the resin is a result of the low compounding temperature required in order to prevent premature cross-linking of the silane grafted resin once the water present in the HFFR is introduced to the grafted resin.

In an attempt to address the issues posed by using silane-grafted ethylene-based polymers, there have also been attempts at utilizing ethylene-silane copolymers. For example, U.S. Pat. No. 5,266,627 (“the '627 patent”) provides a hydrolysable silane copolymer composition that is resistant to premature crosslinking when mixed with HFFR. The '627 patent explains that “ethylene-vinyltrimethoxysilane copolymers . . . are not stable in the presence of the filler, i.e., excessive premature crosslinking is observed during processing or when the filled copolymer is stored under ambient conditions, or the filled copolymer will crosslink excessively, i.e., scorch, during the subsequent processing and extrusion after the silanol condensation catalyst has been added.” (See the '627 patent at column 6, line 60 through column 7, line 3.) Emphasizing this point is comparative example 4 of the '627 patent where a random copolymer of ethylene and vinyltrimethoxysilane having a 2.1% copolymerized vinyltrimethoxysilane content was tested. The '627 patent explains that it is apparent “that the formulation prepared using the . . . [ethylene-silane] random copolymer became highly crosslinked during processing of the filled copolymer with the silanol condensation catalyst” and was therefore unacceptable. (See the '627 patent at column 12, lines 41-48.))

In view of the foregoing, it would be surprising to discover a method of forming an HFFR thermoset polymeric composition that exhibits a hot creep elongation of 50% or less as measured according to ICEA T-28-562, an unaged tensile modulus of 9 mPa or greater as measured according to ASTM D638, and an elongation at break of 150% or greater as measured according to ASTM D638.

### SUMMARY OF THE INVENTION

The present disclosure provides a method of forming an HFFR thermoset polymeric composition that exhibits a hot creep elongation of 50% or less as measured according to ICEA T-28-562, an unaged tensile modulus of 9 mPa or greater as measured according to ASTM D638, and an elongation at break of 150% or greater as measured according to ASTM D638. The inventors of the present application have discovered that by utilizing an ethylene-silane copolymer having a silane content of 0.5 wt % to less than 2 wt % based on the total weight of the ethylene-silane copolymer enables the pre-compounding of HFFR materials with the copolymer. Advantageously, the ethylene-silane copolymer and a HFFER masterbatch can be melt blended and then pelletized for distribution and later use without concerns of premature crosslinking or decreased silane functionality. Further, the pre-compounded HFFR masterbatch and ethylene-silane copolymer can be extruded without exhibiting excessive scorch, but can meet the above noted physical properties.

The present disclosure is particularly useful for the formation of wires and cables.

According to a first aspect, a method of forming a polymeric composition, comprises the steps of melt blending an ethylene-silane copolymer and a halogen free flame retardant masterbatch comprising halogen free flame retardant dispersed in an ethylene vinyl acetate copolymer to form the polymeric composition, wherein the ethylene-silane copolymer is a random copolymer of units derived from ethylene and vinyltrimethoxysilane and further wherein the copolymer has a vinyltrimethoxysilane content of 0.5 wt % to less than 2 wt % based on the total weight of the ethylene-silane copolymer; and processing the polymeric composition into a plurality of particles.

According to a second aspect, the method further comprises the steps of melt blending a condensation cure catalyst with the particles of the polymeric composition; and extruding the combined condensation cure catalyst and polymeric composition to form an article.

According to a third aspect the method further comprises the step of crosslinking the article in the presence of water.

According to a fourth aspect, the halogen free flame retardant masterbatch resin is ethylene vinyl acetate copolymer and the masterbatch comprises 20 wt % to 50 wt % ethylene vinyl acetate copolymer based on a total weight of the halogen free flame retardant masterbatch.

According to a fifth aspect, the step of melt blending an ethylene-silane copolymer and one or more halogen free flame retardants to form the polymeric composition is performed at a temperature of 100° C. or greater.

According to a sixth aspect, the copolymer has a vinyltrimethoxysilane content of 1.2 wt % to 2.0 wt % based on the total weight of the ethylene-silane copolymer.

According to a seventh aspect, the halogen free flame retardant comprises a metal hydroxide.

According to an eighth aspect, the step of melt blending the ethylene-silane copolymer and the halogen free flame retardant to form the polymeric composition is performed with 30 wt % or greater ethylene-silane copolymer based on the total weight of the polymeric composition.

According to a ninth aspect, the step of melt blending the ethylene-silane copolymer and the halogen free flame retardant to form the polymeric composition is performed with 10 wt % or greater halogen free flame retardant based on the total weight of the polymeric composition.

According to a tenth aspect, the polymeric composition comprises from 30 wt % to 70 wt % of the ethylene-silane copolymer based on a total weight of the polymeric composition and 10 wt % to 50 wt % of the halogen free flame retardant based on a total weight of the polymeric composition.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A. B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (° C.) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS #”) refer to the unique numeric identifier as most recently assigned as of the priority date of this document to a chemical compound by the Chemical Abstracts Service.

### Polymeric Composition

The present disclosure is directed to a polymeric composition and a method of making the polymeric composition. The polymeric composition comprises an ethylene-silane copolymer and a halogen free flame retardant masterbatch. The halogen free flame retardant masterbatch comprises halogen free flame retardant and a resin in which the halogen free flame retardant is dispersed. The polymeric composition may comprise one or more of a condensation cure catalyst, antioxidants, and one or more carrier resins. The polymeric composition may further comprise one or more additives as outlined below.

### Ethylene-Silane Copolymer

The ethylene-silane copolymer comprises units derived from ethylene monomer and a silane monomer. A “copolymer” means a macromolecular compound prepared by reacting (i.e., polymerizing) monomers of different types. The ethylene-silane copolymer is prepared by the copolymerization of ethylene and a silane monomer. The ethylene and silane units are arranged in the copolymer in a random orientation such that the ethylene-silane copolymer is a random copolymer of units derived from ethylene and silane.

The polymeric composition may comprise 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less of ethylene-silane copolymer based on the total weight of the polymeric composition.

The ethylene-silane copolymer has a density of 0.910 grams per cubic centimeter (“g/cc”) or greater, or 0.915 g/cc or greater, or 0.920 g/cc or greater, or 0.921 g/cc or greater, or 0.922 g/cc or greater, or 0.925 g/cc to 0.930 g/cc or greater, or 0.935 g/cc or greater, while at the same time, 0.940 g/cc or less, or 0.935 g/cc or less, or 0.930 g/cc or less, or 0.925 g/cc or less, or 0.920 g/cc or less, or 0.915 g/cc or less as measured by ASTM D792.

The ethylene-silane copolymer comprises 90 wt % or greater, or 91 wt % or greater, or 92 wt % or greater, or 93 wt % or greater, or 94 wt % or greater, or 95 wt % or greater, or 96 wt % or greater, or 96.5 wt % or greater, or 97 wt % or greater, or 97.5 wt % or greater, or 98 wt % or greater, or 99 wt % or greater, while at the same time, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of α-olefin as measured using Fourier-Transform Infrared (FTIR) Spectroscopy. The α-olefin may include C₂, or C₃ to C₄, or C₆, or C₈, or C₁₀, or C₁₂, or C₁₆, or C₁₈, or C₂₀ α-olefins, such as ethylene, propylene, 1-butene, 1-hexene, 4-methyl-1-pentene, and 1-octene. Other units of the silane-functionalized polyolefin may be derived from one or more polymerizable monomers including, but not limited to, unsaturated esters. The unsaturated esters may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2-ethylhexyl acrylate. Examples of vinyl carboxylates include, but are not limited to, vinyl acetate, vinyl propionate, and vinyl butanoate.

The ethylene-silane copolymer may comprise 0.5 wt % to 2.00 wt % of copolymerized silane. For example, the ethylene-silane copolymer may comprise 0.50 wt % or greater, or 0.55 wt % or greater, or 0.60 wt % or greater, or 0.65 wt % or greater, or 0.70 wt % or greater, or 0.75 wt % or greater, or 0.80 wt % or greater, or 0.85 wt % or greater, or 0.90 wt % or greater, or 0.95 wt % or greater, or 1.00 wt % or greater, or 1.05 wt % or greater, or 1.10 wt % or greater, or 1.15 wt % or greater or 1.20 wt % or greater, or 1.25 wt % or greater or 1.30 wt % or greater, or 1.35 wt % or greater or 1.40 wt % or greater, or 1.45 wt % or greater or 1.50 wt % or greater, or 1.55 wt % or greater or 1.60 wt % or greater, or 1.65 wt % or greater or 1.70 wt % or greater, or 1.75 wt % or greater or 1.80 wt % or greater, or 1.85 wt % or greater or 1.90 wt % or greater, or 1.95 wt % or greater while at the same time, 2.00 wt % or less, or 1.95 wt % or less, or 1.90 wt % or less, or 1.85 wt % or less, or 1.80 wt % or less, or 1.75 wt % or less, or 1.70 wt % or less, or 1.65 wt % or less, or 1.60 wt % or less, or 1.55 wt % or less, or 1.50 wt % or less, or 1.45 wt % or less, or 1.40 wt % or less, or 1.35 wt % or less, or 1.30 wt % or less, or 1.25 wt % or less, or 1.20 wt % or less, or 1.15 wt % or less, or 1.10 wt % or less, or 1.05 wt % or less, or 1.00 wt % or less, or 0.95 wt % or less, or 0.90 wt % or less, or 0.85 wt % or less, or 0.80 wt % or less, or 0.75 wt % or less, or 0.70 wt % or less, or 0.65 wt % or less, or 0.60 wt % or less, or 0.55 wt % or less of copolymerized silane based on the total mass of ethylene-silane copolymer. The content of copolymerized silane present in the ethylene-silane copolymer is determined through Silane Testing as explained in greater detail below.

The silane comonomer used to make the ethylene-silane copolymer may be a hydrolyzable silane monomer. A “hydrolyzable silane monomer” is a silane-containing monomer that will effectively copolymerize with an α-olefin (e.g., ethylene) to form an α-olefin-silane copolymer (such as an ethylene-silane reactor copolymer). The hydrolyzable silane monomer has structure (I):

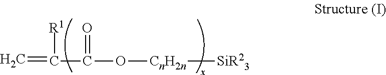

in which R¹ is a hydrogen atom or methyl group; x is 0 or 1; n is an integer from 1 to 4, or 6, or 8, or 10, or 12; and each R₂ independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl. The hydrolyzable silane monomer may be copolymerized with an α-olefin (such as ethylene) in a reactor, such as a high-pressure process to form an α-olefin-silane reactor copolymer. In examples where the α-olefin is ethylene, such a copolymer is referred to herein as an ethylene-silane copolymer.

The hydrolyzable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the polyolefin or copolymerized in-reactor with an α-olefin (such as ethylene). Examples of hydrolyzable silane monomers include vinyltrimethoxysilane (“VTMS”), vinyltriethoxysilane (“VTES”), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹═H; and R²=acetoxy.

### Halogen-Free Flame Retardant Masterbatch

As stated above, the halogen free flame retardant masterbatch includes the halogen free flame retardant and the resin. The halogen-free flame retardant of the polymeric composition can inhibit, suppress, or delay the production of flames. Examples of the halogen-free flame retardants suitable for use in the polymeric composition include, but are not limited to, metal hydrates, metal carbonates, red phosphorous, silica, alumina, aluminum hydroxide, magnesium hydroxide, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds, expanded graphite, and combinations thereof. In an embodiment, the halogen-free flame retardant can be selected from the group consisting of aluminum hydroxide, magnesium hydroxide, calcium carbonate, and combinations thereof. The halogen-free flame retardant can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442, 7,514,489, US 2008/0251273, and WO 2013/116283. Alternatively, the acid or salt can be merely added to the composition in like amounts rather than using the surface treatment procedure. Other surface treatments known in the art may also be used including silanes, titanates, phosphates and zirconates.

Commercially available examples of halogen-free flame retardants suitable for use in the polymeric composition include, but are not limited to, APYRAL™ 40CD aluminum hydroxide available from Nabaltec AG, MAGNIFIN™ H5 magnesium hydroxide available from Magnifin Magnesiaprodukte GmbH & Co KG, Microcarb 95T ultramicronized and treated calcium carbonate available from Reverte, and combinations thereof.

The polymeric composition may comprise halogen-free flame retardants in a concentration of 10 wt % or greater, or 12 wt % or greater, or 14 wt % or greater, or 16 wt % or greater, or 18% or greater, or 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, 40 wt % or greater, or 42 wt % or greater, or 44 wt % or greater, or 46 wt % or greater, or 48% or greater, or 50 wt % or greater, or 52 wt % or greater, or 54 wt % or greater, or 56 wt % or greater, or 58% or greater, or 60 wt % or greater, or 62 wt % or greater, or 64 wt % or greater, or 66 wt % or greater, or 68% or greater, or 70 wt % or greater, or 72 wt % or greater, or 74 wt % or greater, or 76 wt % or greater, or 78% or greater, while at the same time, 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less based on the weight of the polymeric composition.

As explained in greater detail below, the HFFR is added to the ethylene-silane copolymer as a “masterbatch” or as a pre-compounded material. The HFFR is dispersed within the resin of the masterbatch and may include one or more other compounds. The HFFR may be present within the masterbatch from about 40 wt % to 90 wt % based on the total weight of the masterbatch. For example, the HFFR may be present in the masterbatch in an amount of 40 wt % or greater, or 42 wt % or greater, or 44 wt % or greater, or 46 wt % or greater, or 48% or greater, or 50 wt % or greater, or 52 wt % or greater, or 54 wt % or greater, or 56 wt % or greater, or 58% or greater, or 60 wt % or greater, or 62 wt % or greater, or 64 wt % or greater, or 66 wt % or greater, or 68% or greater, 70 wt % or greater, or 72 wt % or greater, or 74 wt % or greater, or 76 wt % or greater, or 78% or greater, while at the same time, 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less based on the total weight of the masterbatch.

The resin of the masterbatch may include one or more polymeric resins in which the HFFR is dispersed. One example of a suitable resin of the masterbatch is ethylene-vinyl acetate copolymer. The ethylene-vinyl acetate may have a vinyl acetate content of 18 wt % or greater, or 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, 40 wt % or greater, or 42 wt % or greater, or 44 wt % or greater, or 46 wt % or greater, or 48% or greater, while at the same time, 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less based on the total weight of the ethylene-vinyl acetate. The masterbatch may include the resin in an amount of 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, 40 wt % or greater, or 42 wt % or greater, or 44 wt % or greater, or 46 wt % or greater, or 48% or greater, while at the same time, 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % based on the total weight of the masterbatch. Any of the below noted additives for the polymeric composition may be included in the masterbatch.

### Additives

The polymeric composition may comprise additional additives in the form of antioxidants, cross-linking co-agents, cure boosters and scorch retardants, processing aids, coupling agents, ultraviolet stabilizers (including UV absorbers), antistatic agents, additional nucleating agents, slip agents, lubricants, viscosity control agents, tackifiers, anti-blocking agents, surfactants, extender oils, acid scavengers, flame retardants, anti-drip agents (e.g., ethylene vinyl acetate, silicone rubber, etc.) and metal deactivators. The polymeric composition may comprise from 0.01 wt % to 20 wt % of one or more of the additional additives.

The UV light stabilizers may comprise hindered amine light stabilizers (“HALS”) and UV light absorber (“UVA”) additives. Representative UVA additives include benzotriazole types such as TINUVIN 326™ light stabilizer and TINUVIN 328™ light stabilizer commercially available from Ciba, Inc. Blends of HAL's and UVA additives are also effective.

The antioxidants may comprise hindered phenols such as tetrakis[methylene(3,5-di-tert-butyl-4-hydroxyhydro-cinnamate)]methane; bis[(beta-(3,5-ditert-butyl-4-hydroxybenzyl) methylcarboxyethyl)]-sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)-hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine anti-degradants or stabilizers.

The processing aids may comprise metal salts of carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids and polysiloxanes.

### Method of Forming the Polymeric Composition

The formation of the polymeric composition begins with a step of melt blending the ethylene-silane copolymer and the halogen free flame retardant masterbatch to form the polymeric composition. The melt blending may be performed at a temperature of 100° C. or greater, or 120° C. or greater, or 140° C. or greater, or 160° C. or greater, or 180° C. or greater, or 200° C. or greater, or 220° C. or greater, or 240° C. or greater, or 260° C. or greater, or 280° C. or greater, or 300° C. or greater. The melt blending may be carried out in a batch or continuous mixer and the components may be added in any order. Examples of compounding equipment used include internal batch mixers, such as a BANBURY™ or BOLLING™ internal mixer. Alternatively, continuous single, or twin screw, mixers can be used, such as FARRELL™ continuous mixer, a WERNER™ and PFLEIDERER™ twin screw mixer, or a BUSS™ kneading continuous extruder. The type of mixer utilized, and the operating conditions of the mixer, will affect properties of the composition such as viscosity, volume resistivity, and extruded surface smoothness.

After the step of melt blending the ethylene-silane copolymer and the halogen free flame retardant masterbatch to form the polymeric composition is complete, a step of processing the polymeric composition into a plurality of particles is performed. The step of processing the polymeric composition may include pelletizing, grinding, powdering and/or other forms of producing the plurality of particles of the polymeric composition. The particles may have a longest length dimension (i.e., diameter, length, etc.) of 0.001 mm or greater, or 0.01 mm or greater, or 0.1 mm or greater, or 1.0 mm or greater, or 2 mm or greater, or 3 mm or greater, or 4 mm or greater, or 5 mm or greater, or 6 mm or greater, or 7 mm or greater, or 8 mm or greater, or 9 mm or greater, while at the same time, 10 mm or less, or 5 mm or less, or 1 mm or less. The particles may take a variety of shapes including spheroid, discs, barrels, filaments, other shapes, and combinations thereof.

After the polymeric composition has been processed into a plurality of particles, a step of melt blending a condensation cure catalyst with the particles of the polymeric composition is performed. The condensation cure catalyst promotes the crosslinking of the ethylene-silane copolymer. The condensation cure catalyst may include lewis acids and bases, and bronsted acids and bases. Lewis acids are chemical species that can accept an electron pair from a lewis base. Lewis bases are chemical species that can donate an electron pair to a lewis acid. Non-limiting examples of suitable lewis acids include tin carboxylates such as dibutyltin dilaurate (DBTDL), dimethylhydroxytin oleate, dioctyltin maleate, di-n-butyltin maleate, dibutyltin diacetate, dibutyltin dioctoate, stannous acetate, stannous octoate, and various other organometallic compounds such as lead naphthenate, zinc octoate, and cobalt naphthenate. Non-limiting examples of suitable lewis bases include primary, secondary, and tertiary amines.

After the step of melt blending the condensation cure catalyst with the polymeric composition is performed, a step of extruding the combined condensation cure catalyst and polymeric composition to form an article is performed. The article may take a variety of forms such a strip, tape, film, coated conductor and/or other forms. In coated conductor examples of the article, the coated conductor includes a conductor and a coating on the conductor, the coating including the polymeric composition. The polymeric composition is at least partially disposed around the conductor to produce the coated conductor. The process for producing a coated conductor article includes mixing and heating the polymeric composition to at least the melting temperature of the ethylene-silane copolymer in an extruder, and then coating the polymeric melt blend onto the conductor. The term “onto” includes direct contact or indirect contact (i.e., with one or more intervening layers such) between the polymeric melt blend and the conductor. The conductor may be an electrically conductive or optically transmissive structure. The polymeric composition is disposed on and/or around the conductor to form a coating. The coating may be one or more inner layers such as an insulation layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor. The coating may be a jacketing layer surrounding one or more conductors.

Once the article has been formed, a step of crosslinking the article in the presence of water is performed. The crosslinking can be carried out at a temperature greater than 70° C. The cable may be cured for 4 or more hours, or 6 or more hours, or 8 or more hours at a temperature of 70° C. or greater, or 80° C. or greater, or 90° C. or greater, or 95° C. or greater, while at the same time 110° C. or less. As defined herein, the term “in the presence of water” is defined to mean in a water bath or in an environment having a relative humidity of 80% or greater. The presence of water initiates the condensation cure catalyst to cause the ethylene-silane copolymer to crosslink.

### EXAMPLES

### Materials

SiPO is an ethylene-silane copolymer having a density of 0.922 g/cc, a crystallinity at 23° C. of 46.9 wt % and a melt index of 1.5 g/10 min (190° C./2.16 kg), an alkoxy silane content of 1.3 wt % to 1.7 wt %. and is commercially available as SI-LINK™ DFDA-5451 NT from The Dow Chemical Company, Midland, Michigan.

EVA1 is an ethylene-vinyl acetate copolymer having a 28 wt % vinyl acetate comonomer content, a density of 0.95 g/cc as measured according to ASTM D792 and a melt index of 3 g/10 min at 190° C./21.6 kg as measured according to ASTM D1238 and commercially available as ELVAX™ 3182 from The Dow Chemical Company, Midland, Michigan.

EVA2 is an ethylene-vinyl acetate copolymer having a 40 wt % vinyl acetate comonomer content, a density of 0.967 g/cc as measured according to ASTM D792 and a melt index of 3 g/10 min at 190° C./21.6 kg as measured according to ASTM D1238 and commercially available as ELVAX™ 40L-03 from The Dow Chemical Company, Midland, Michigan.

HFFR is magnesium hydroxide, an example of which is commercially available under the tradename MAGNIFIN™ H-5MV from the Albemarle Corporation Charlotte, NC, USA.

AO is tetrakis[methylene-3-(3,5-di-tert-butyl-4-hydroxyphenyl)propionate] methane having a CAS number of 6683-19-8 and is commercially available under the tradename SONGNOX™ 1010 from Songwon Industrial, South Korea.

Compatibilizer is a maleic anhydride grafted ethylene vinyl acetate copolymer and is commercially available as FUSABOND™ N493 from The Dow Chemical Company, Midland, MI.

Catalyst is a catalyst masterbatch blend of polyolefins, phenolic compounds, and 2.6 wt % of dibutyltin dilaurate as silanol condensation catalyst.

LDPE is a low density polyethylene having a density of 0.92 g/cc as measured according to ASTM D792 and a melt index of 1.7 to 2.1 g/10 min at 190° C./21.6 kg as measured according to ASTM D1238 and is available from The Dow Chemical Company, Midland, Michigan.

VTMS is vinyl trimethyl siloxane available under the tradename SILQUEST™ Y-9818 from Momentive, Waterford, NY.

DCP is dicumyl peroxide having a 99 wt % or greater concentration and is available as PERKADOX™ from Nouryon, Amsterdam, Netherlands

### Test Methods

Hot Creep: Hot creep of a sample is measured according to ICEA T-28-562.

Tensile Modulus: Tensile modulus is measured according to ASTM D638.

Elongation at Break: Elongation at Break is measured according to ASTM D638.

### Sample Preparation

The samples were prepared according to one of three different mixing methods. The three mixing methods include an inventive method and two comparative methods. The samples produced from the inventive method are inventive examples (“IE”) and the samples produced from the comparative methods are comparative examples (“CE”).

In inventive method 1, moisture crosslinkable HFFR formulations A and B were prepared following the inventive method of blending the ethylene-silane copolymer with a HFFR compound/masterbatch. The HFFR masterbatches compositions are provided in Table 1.

TABLE 1

| | MB-1 | MB-2 |
|---|---|---|
| Material | (wt %) | (wt %) |
| EVA1 | 29.75 | |
| EVA2 | | 24.75 |
| HFFR | 65 | 70 |
| Compatibilizer | 5 | 5 |
| AO | 0.25 | 0.25 |

The HFFR masterbatches were prepared in a BRABENDER™ mixing bowl where the material was mixed for 15 minutes at 150° C. with a rotor speed of 30 revolutions per minute (“RPM”), the batch was then discharged, cooled then granulated. The masterbatches were evaluated for dispersion quality by extruding a tape and visually inspecting for surface smoothness. The tape was extruded on a 19 mm BRABENDER™ extruder using a polyethylene screw without a screenpack with a barrel profile of 160° C., 170° C., 180° C. with a melt temperature of less than 180° C. A 0.51 mm thick tape was made and its smoothness, which is an indication of the dispersion, was deemed acceptable.

The masterbatches (MB-1, MB-2) were then mixed with the silane-ethylene copolymer in a BRABENDER™ mixing bowl for 15 minutes at 150° C. with a rotor speed of 30 RPM to produce moisture crosslinkable HFFR formulations A and B as provided in Table 2. The moisture crosslinkable HFFR formulations were then discharged from the mixer, cooled then granulated.

TABLE 2

| | A | B |
|---|---|---|
| Materials | (wt %) | (wt %) |
| SiPO | 50 | 50 |
| MB-1 | 50 | |
| MB-2 | | 50 |

To produce IE1 and IE2, crosslinkable formulations A and B were dry blended with the catalyst as provided in Table 3.

TABLE 3

| | IE1 | IE2 |
|---|---|---|
| Materials | (wt %) | (wt %) |
| A | 97 | 0 |
| B | 0 | 97 |
| Catalyst | 3 | 3 |

Prior to the dry blending, crosslinkable formulations A and B were dried overnight in a 60° C. oven. The dry blended mixtures were extruded on a 19 mm BRABENDER™ extruder with a polyethylene/Maddock mixing screw with a 60 mesh screenpack using a barrel profile of 160° C., 170° C., 180° C. with a melt temperature of less than 180° C. Though a 1.778 mm die opening was used, the tape was drawn down to a 1.27 mm thickness for property testing. The tape was inspected for quality and no signs of scorch were seen. The tapes were cured for 8 hours in a 90° C. water bath.

In comparative method 2, moisture crosslinkable HFFR formulations C and D were prepared in a BRABENDER™ mixing bowl by compounding all the ingredients of Table 4 in a single step.

TABLE 4

| | C | D |
|---|---|---|
| Materials | (wt %) | (wt %) |
| SiPO | 49.9 | 49.9 |
| EVA1 | 15 | |
| EVA2 | | 12.5 |
| HFFR | 32.5 | 35 |
| Compatibilizer | 2.5 | 2.5 |
| AO | 0.1 | 0.1 |

The ethylene-silane copolymer, EVA polymer, HFFR and other additives were added to the BRABENDER™ mixer then mixed for 15 minutes at 150° C. with a rotor speed of 30 RPM. The batch was discharged from the mixer, cooled then granulated. The crosslinkable formulations were evaluated for dispersion quality by extruding a tape and visually inspecting for surface smoothness. The tape was extruded on a 19 mm BRABENDER™ extruder using a polyethylene screw without a screenpack with a barrel profile of 160° C., 170° C., 180° C. with a melt temp of less than 180° C. A 0.508 mm thick tape was made and its smoothness was deemed acceptable.

To produce CE1 and CE2 via the first comparative method, crosslinkable formulations C and D were dry blended with a crosslinking catalyst per table 5.

TABLE 5

| | CE1 | CE2 |
|---|---|---|
| Materials | (wt %) | (wt %) |
| C | 97 | 0 |
| D | 0 | 97 |
| Catalyst | 3 | 3 |

Prior to the dry blending, moisture crosslinkable formulations C and D were dried overnight in a 60° C. oven. The dry blended mixtures were extruded on a 19 mm BRABENDER™ extruder with a polyethylene/Maddock mixing screw with a 60 mesh screenpack using a barrel profile of 160° C., 170° C., 180° C. with a melt temperature of less than 180° C. Though a 1.778 mm die opening was used, the tape was drawn down to a 1.27 mm thickness for property testing. The tape was inspected for quality and no signs of scorch were seen. The tapes were cured for 8 hours in a 90° C. water bath.

In comparative method 2, to prepare CE3 and CE4 a silane grafted polyethylene (“Si-g-PE”) was produced. The Si-g-PE was had a concentration of 98 wt % LDPE, 1.82 wt % VTMS and 0.18 wt % DCP. Grafting of the VTMS to the LDPE was conducted by first fluxing the LDPE, adding the VTMS and the DCP materials and mixing for 3-5 minutes at 190° C. with a rotor speed of 30 RPM. Then the batch temperature was lowered to 150° C. at a rotor speed of 10 RPM. The HFFR along with other additives were compounded into the Si-g-PE polymer as provided in Table 6 to form crosslinkable formulations E and F.

TABLE 6

| | E | F |
|---|---|---|
| Material | (wt %) | (wt %) |
| Si-g-PE | 49.9 | 49.9 |
| EVA1 | 15 | |
| EVA2 | | 12.5 |
| HFFR | 32.5 | 35 |
| Compatibilizer | 2.5 | 2.5 |
| AO | 0.1 | 0.1 |

Mixing of the crosslinkable formulations E and F was performed in a BRABENDER™ mixing bowl. The material was mixed for 15 minutes at 190° C. with a rotor speed of 30 RPM. The batch was then discharged, pressed flat, cooled and granulated. The crosslinkable formulations were then evaluated for dispersion by visually inspecting an extruded tape. The tape was extruded on a 19 mm BRABENDER™ extruder using a polyethylene screw without a screenpack with a barrel profile of 160° C., 170° C., 180° C. with a melt temp of less than 180° C. A 0.508 mm thick tape was made and its smoothness was deemed acceptable.

To produce CE3 and CE4 via comparative mixing process 2, the crosslinkable formulations E and F were crosslinked by dry blend mixing the granulated crosslinkable material with a crosslinking catalyst as shown in Table 7.

TABLE 7

| | CE3 | CE4 |
|---|---|---|
| Materials | (wt %) | (wt %) |
| E | 97 | 0 |
| F | 0 | 97 |
| Catalyst | 3 | 3 |

Prior to the dry blending, crosslinkable formulations E and F were dried overnight in a 60° C. oven. The dry blended mixtures were extruded on a 19 mm BRABENDER™ extruder with a polyethylene/Maddock mixing screw with a 60 mesh screenpack using a barrel profile of 160° C., 170° C., 180° C. with a melt temperature of less than 180° C. Though a 1.778 mm die opening was used, the tape was drawn down to a 1.27 mm thickness for property testing. The tape was inspected for quality and no signs of scorch were seen. The tapes were cured for 8 hours in a 90° C. water bath.

Test specimens for each inventive and comparative example were prepared from the tapes by die cutting “dog bone” specimens for mechanical property testing.

### Results

The results of mechanical property testing of IE1, IE2 and CE1-CE4 are provided in Table 8.

TABLE 8

| Property | IE1 | IE2 | CE1 | CE2 | CE3 | CE4 |
|---|---|---|---|---|---|---|
| Hot Creep | 27 | 29 | 68 | 77 | 52 | 53 |
| Elongation (%) | | | | | | |
| Tensile | 12.41 | 10.89 | 10.00 | 9.79 | 10.89 | 9.37 |
| Modulus (mPa) | | | | | | |
| Elongation | 310 | 270 | 280 | 200 | 170 | 140 |
| at break (%) | | | | | | |

As self-evident from Table 8, utilizing the inventive method produces samples (i.e., IE1 and IE2) that achieve a hot creep elongation of 50% or less as measured according to ICEA T-28-562, an unaged tensile modulus of 9 mPa or greater as measured according to ASTM D638, and an elongation at break of 150% or greater as measured according to ASTM D638. IE1 and IE2 are able to achieve these properties as crosslinking performance has been increased (i.e., as indicated by the lower hot creep values and better tensile and elongation properties) as compared to the comparative examples. Contrary to IE1 and IE2, it can be seen from CE1 and CE2 that the mixing of all materials at once leads to unacceptably low curing as demonstrated by the hot creep elongation being above 50%. CE3 and CE4 demonstrate that the use of a silane grafted ethylene polymer leads to unacceptably low cure and an elongation at break which is well below the desired properties.

1. A method of forming a polymeric composition, comprising the steps of:
melt blending an ethylene-silane copolymer and a halogen free flame retardant masterbatch comprising halogen free flame retardant dispersed in an ethylene vinyl acetate copolymer to form the polymeric composition, wherein the ethylene-silane copolymer is a random copolymer of units derived from ethylene and vinyltrimethoxysilane and further wherein the copolymer has a vinyltrimethoxysilane content of 0.5 wt % to less than 2 wt % based on the total weight of the ethylene-silane copolymer; and
processing the polymeric composition into a plurality of particles.

2. The method of claim 1, further comprising the steps of:
melt blending a condensation cure catalyst with the particles of the polymeric composition; and
extruding the combined condensation cure catalyst and polymeric composition to form an article.

3. The method of claim 2, further comprising the step of:
crosslinking the article in the presence of water.

4. The method of claim 1, wherein the masterbatch comprises 20 wt % to 50 wt % ethylene vinyl acetate copolymer based on a total weight of the halogen free flame retardant masterbatch.

5. The method of claim 1, wherein the step of melt blending an ethylene-silane copolymer and one or more halogen free flame retardants to form the polymeric composition is performed at a temperature of 100° C. or greater.

6. The method of claim 1, wherein the copolymer has a vinyltrimethoxysilane content of 1.2 wt % to 2.0 wt % based on the total weight of the ethylene-silane copolymer.

7. The method of claim 1, wherein the halogen free flame retardant comprises a metal hydroxide.

8. The method of claim 1, wherein the step of melt blending the ethylene-silane copolymer and the halogen free flame retardant to form the polymeric composition is performed with 30 wt % or greater ethylene-silane copolymer based on the total weight of the polymeric composition.

9. The method of claim 1, wherein the step of melt blending the ethylene-silane copolymer and the halogen free flame retardant to form the polymeric composition is performed with 10 wt % or greater halogen free flame retardant based on the total weight of the polymeric composition.

10. The method of claim 1, wherein the polymeric composition comprises from 30 wt % to 70 wt % of the ethylene-silane copolymer based on a total weight of the polymeric composition and 10 wt % to 50 wt % of the halogen free flame retardant based on a total weight of the polymeric composition.
